(19) United States
(12) Patent Application Publication
(10) Pub. No.: US 2016/0032587 A1
(43) Pub. Date: Feb. 4, 2016

(54) SINGLE AND MULTI-PART PREFABRICATED INTERIOR FINISH LAYER ASSEMBLIES, BUILDING WALL ASSEMBLIES, AND METHODS OF MANUFACTURING THESE ASSEMBLIES

(71) Applicant: BLU HOMES, INC., Waltham, MA (US)

(72) Inventors: Dennis Michaud, Groton, MA (US); Ronald Rezac, Bolton, MA (US)

(21) Appl. No.: 14/775,234

(22) PCT Filed: Mar. 6, 2014
(86) PCT No.: PCT/US14/21037

§ 371 Date: Sep. 11, 2015

Related U.S. Application Data
(60) Provisional application No. 61/784,544, filed on Mar. 14, 2013.

(51) Int. Cl. E04C 2/52; E04F 17/08; E04B 2/00; H02G 3/04; E04B 2/42

(52) U.S. Cl. CPC E04C 2/521; H02G 3/04; E04B 2/42; E04C 2/46; E04F 17/08

(57) ABSTRACT

Building technology including building wall assemblies, prefabricated interior finish layers, and prefabricated multi-part interior finish layers are presented that establish a space between a structural layer of a building wall and a respective interior finish layer. Electrical wiring and/or plumbing is nm through this space while being held by a protective track which shields the electrical wiring and/or plumbing from potentially damaging impacts originating through the interior finish layer. This building technology is advantageously used in conventional building, for prefabricated buildings, and particularly, for prefabricated foldable buildings, by allowing more time and cost efficient wall construction, providing more electrical wiring and plumbing flexibility, facilitating prefabrication, and/or facilitating changes to electrical wiring and plumbing in finished buildings, for example, in later renovation projects.

### RELATED APPLICATION(S)

This application claims the benefit of U.S. Provisional Application No. 61/784,544, filed on Mar. 14, 2013. The entire teachings of that application are incorporated herein by reference.

### BACKGROUND OF THE INVENTION

In conventional building, electrical wiring and plumbing are primarily installed within the structural layer of a building wall assembly. Typically, electrical wiring and plumbing are installed such that they are several inches spaced apart from the interior finish layer in the completed wall. Electrical wiring and plumbing are typically affixed (e.g., stapled) to and/or run through members such as wood studs of the structural layer. In this conventional approach, electrical wiring and plumbing are installed, for new construction, prior to installation of respective interior finish layers, leading to a time-inefficient wall assembly building process with several phases, as well as increasing the challenge (and associated labor) of synchronizing plumbing and electrical layouts (hidden with the structure) with the desired location of outlets, switches, lights, network drops, cable outlets, faucets, toilets, and other electrical, communications, and plumbing fixtures and receptacles. If the locations of these runs is not in synchronization with the desired location of the fixtures and receptables, this information is only known after the interior finish layer has been installed, when any changes including additions to the electrical wiring and plumbing are difficult and costly because access to the space of the structural layer in which the electrical wiring and plumbing has been run is difficult, often requiring removal of the interior finish layer, changes to the structure, and costly subsequent refinishing.

There is, therefore, a need for new building technology that allows more time-and cost-efficient wall construction, provides more electrical wiring and plumbing flexibility, facilitates prefabrication, and/or facilitates changes to electrical wiring and plumbing in the finished building, for example, in later renovation projects.

### SUMMARY OF THE INVENTION

The building technology of the present invention establishes a space between a structural layer of a building wall and a respective interior finish layer. Electrical wiring and/or plumbing is run through this space while being held by a protective track which shields the electrical wiring and/or plumbing from potentially damaging impacts originating through the interior finish layer.

With this building technology, electrical wiring and/or plumbing can be connected to interior finish layers facilitating prefabrication, for example, of prefabricated interior finish layer assemblies of the present invention. These prefabricated interior finish layer assemblies can include electrical wiring and/or plumbing held by protective tracks affixed to the interior finish layer, or wiring and/or electrical plumbing can be easily run through the protective tracks at the building site, reducing the time needed for wall construction. Further, future repairs and improvements to the electrical wiring and/or plumbing are easily and cost effectively achieved within the space between the structural layer and the interior finish layer.

The building technology of the present invention provides advantages for conventional building, and is of particular relevance in the manufacture of prefabricated buildings and even more particularly for the manufacture of steel-frame based foldable buildings.

A first embodiment of the present invention is a building wall assembly. The building wall assembly includes a structural layer, at least two sleepers, an interior finish layer, and a protective track. The interior finish layer is affixed to the sleepers and the sleepers are affixed to the structural layer such as to space apart the structural layer and the interior finish layer to form a space.

A second embodiment of the present invention is a prefabricated interior finish layer assembly. The assembly includes an interior finish layer and a protective track. The interior finish layer is affixed to the sleepers, the protective track is affixed to the interior finish layer, and the protective track has a smaller dimension than the sleepers in perpendicular direction to the interior finish layer.

A third embodiment of the present invention is a multi-part prefabricated interior finish layer assembly. The assembly includes a plurality of unconnected prefabricated interior finish layer assemblies of the present invention, for example, of the second embodiment. The prefabricated interior finish layer assemblies, when connected to each other form a continuous interior finish layer in which electrical wiring and/or plumbing is continuously shielded by the protective tracks across the prefabricated interior finish layer assemblies.

A fourth embodiment of the present invention is a building wall assembly. The building wall assembly is manufactured in a process which includes building a structural layer of a wall and affixing a prefabricated interior finish layer assembly to the structural layer such as to space apart the structural layer and the interior finish layer to form a space, a protective track being positioned within the space.

A fifth embodiment of the present invention is a method of manufacturing a prefabricated interior finish layer assembly. The method comprises (i) affixing a plurality of sleepers to an interior finish layer, and (ii) affixing at least one protective track to the interior finish layer.

A sixth embodiment of the present invention is a method of manufacturing a multi-part prefabricated interior finish layer assembly. The method includes (i) affixing a plurality of sleepers to each of a plurality of unconnected interior finish layers, and (ii) affixing at least one protective track to each of the plurality of interior finish layers. The plurality of interior finish layers, when connected, complement each other to form a continuous interior finish layer, and adjacent protective tracks of the plurality of interior finish layers connect to form a continuous protective track along the continuous interior finish layer.

A seventh embodiment of the present invention is a method of manufacturing a building wall assembly. The method includes (a) building a structural layer of a wall, (i) affixing a plurality of sleepers to an interior finish layer, (ii) affixing a protective track to the interior finish layer and/or the structural layer, (iii) connecting the interior finish layer to the structural layer by affixing the sleepers to the structural layer such as to space apart the structural layer and the interior finish layer to form a space, the protective track being positioned within the space.

An eighth embodiment of the present invention is a folded building having a plurality of walls, one or more of the walls comprising a building wall assembly of the present invention, for example, the building wall assembly of the first, fourth or seventh embodiment.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic vertical, cross-sectional view of a building wall assembly according to an exemplary embodiment of the present invention.

FIG. 2 is a schematic vertical, cross-sectional view of a building wall assembly according to another exemplary embodiment of the present invention.

FIG. 3 is a schematic cross-sectional view of four exemplary embodiments of the prefabricated interior finish layer assemblies of the present invention.

FIG. 4 is a schematic isometric view of a prefabricated interior finish layer assembly similar to the embodiment depicted in FIG. 3 (c).

FIG. 5 is a schematic elevational view of a multi-part (here, three part) prefabricated interior finish layer assembly in connected configuration.

### DETAILED DESCRIPTION OF THE INVENTION

A description of example embodiments of the invention follows.

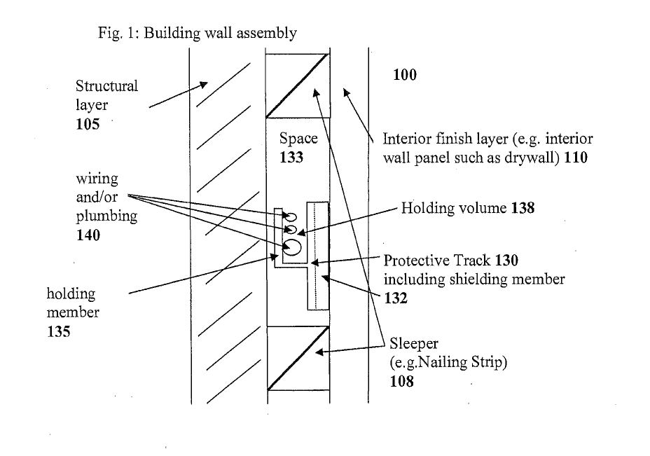

FIG. 1 is a schematic, vertical cross-sectional view of a building wall assembly according to an exemplary embodiment of the present invention. The building wall assembly 100 includes a structural layer 105 (e.g. a wood based structural frame, a hybrid, wood-metal structural frame, a concrete layer, light-gauge steel frame, or structural steel frame; preferably a hybrid, wood-metal structural frame), at least two sleepers 108 (e.g., nailing strips), an interior finish layer 110 (e.g., interior wall panel such as drywall which itself can be in finished condition, e.g., painted), and a protective track 130 including a shielding member 132. The interior finish layer 110 is affixed to the sleepers 108 and the sleepers 108 are affixed to the structural layer 105 such as to space apart the structural layer 105 and the interior finish layer 110 to form a space 133. The protective track 130 is positioned in the space 133.

The sleepers 108 are suitably positioned to allow secure affixment of the interior finish layer 110 to the structural layer 105. Although the sleepers 108 of FIGS. 1 to 4 are shown to be of rectangular cross-section, the sleepers 108 shown in the figures, and more generally, of the embodiments of the present invention, are not limited to this particular rectangular cross-section. They are also not limited to any particular length (i.e., with the length direction being the direction perpendicular to the cross-sectional view plane of FIG. 1). However, the spacers 108 when affixed to both the interior finish layer 110 and the structural layer 105 are required to space apart the interior finish layer and the structural layer to form a space suitable for positioning of the protective track 130. This said, a wide variety of sleeper design known in the building technology can be used as long as the interior finish layer can be securely affixed with the sleepers to the structural layer while meeting any applicable building code standards.

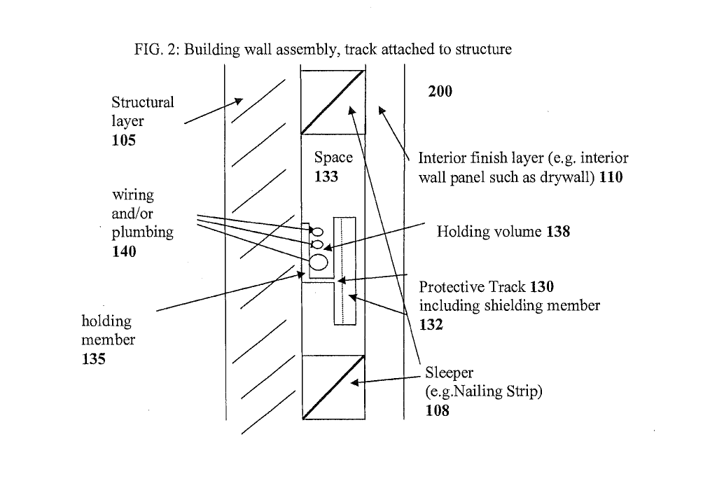

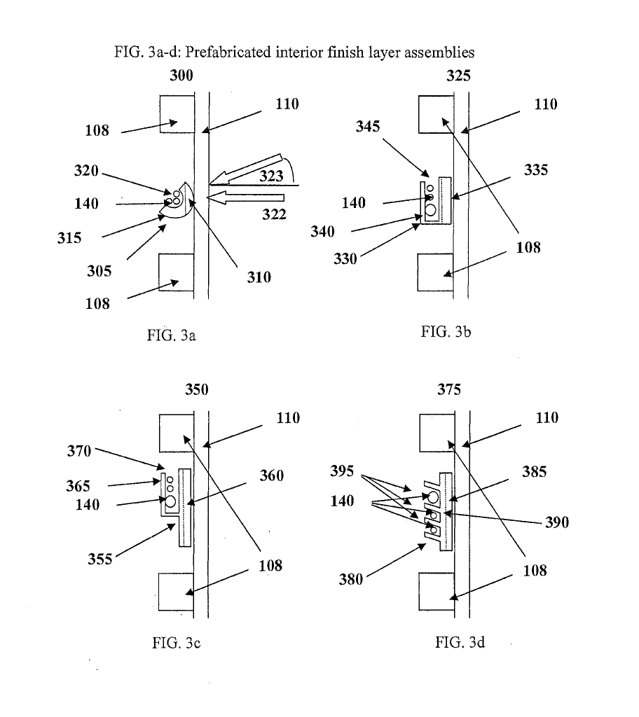

Depending on the geometry of the structural layer, the space 133 can be unchanged across (i.e., in the direction perpendicular to the cross-sectional view plane of FIG. 1) the interior finish layer, or the space can increase. For example, in conventional wood-frame construction, the structural layer includes a plurality of connected wood frame members defining hollow sections within the structural layer. Thus, when the sleepers 108 are affixed to such wood frame members, the space 133 is typically smaller in the areas where the sleepers 108 are affixed to the wood frame members and larger in the areas between the wood frame members where the hollow sections of the structural layer are located. FIG. 1 provides the cross-sectional view in the area where the sleepers 108 are affixed to the structural layer 105. Part of the protective track 130, and even wiring and/or plumbing 140 without protective track can be located within the hollow sections of a wood-frame based structural layer. The protective track 130 shown in FIG. 1 is affixed to the interior finish layer 110; however, the protective track 130, and generally, the protective tracks of the present invention, can be (1) attached to the interior layer 110 only, (2) attached to the structural layer 105 only (such as in FIG. 2), or (3) attached to both interior layer 110 and structural layer 105. Further, although the building wall assembly of FIG. 1 is shown with the specific protective track 130, the building wall assembly is not limited to this particular protective track. Many other protective tracks that can be substituted with the particular protective track 130 of FIG. 1 are readily envisionable, for example, the protective tracks of FIG. 2. The protective track 130 of FIG. 1 as well as the protective tracks shown in FIG. 3 include a shielding member 132 and a holding member 135 (the dividing line between these members is indicated in FIG. 1 and FIG. 3 with a dotted line), and the shielding member 132 and/or the holding member 135 providing a holding volume 138 adapted for holding wiring and/or plumbing 140 either loosely, or in such a form and manner as to secure the wiring and/or plumbing in place (via press-fit or shape fitting connections). Although, the shielding member 132 and the holding member 135 are indicated with separate numbers in FIG. 1, and generally throughout the description, these members can be a single member, for example, made out of one material (e.g., polymer or metal), or a combination of members, that is, a shielding member made out of a first material (e.g., polymer or metal), and a holding member made out of a second material (e.g., polymer or metal), wherein the first and second materials can be the same or different. The protective tracks of the present invention, including the exemplary protective tracks shown in FIG. 1 can be made of a wide variety of material or material combination in a wide variety of shape or form that fulfills the required dual functionality of shielding a holding volume from impacts originating through the interior finish layer 100 and holding wiring and/or plumbing 140 in the holding volume 138. Preferably, to reduce cost and allow increased material selection, the protective track has a shielding member that shields the holding volume from one side only (e.g., the side facing the interior finish layer 100), as is the case for the protective tracks 130 of FIG. 1 and the protective tracks of FIG. 2. Accordingly, preferably, the shielding member 132 is positioned between the holding volume 138 and the interior finish layer 110.

FIG. 2 is a schematic, vertical cross-sectional view of a building wall assembly according to an exemplary embodiment of the present invention. All elements shown in the embodiment of FIG. 2 are as described for FIG. 1, the difference being that the protective track 130 is affixed to the structural layer 105.

FIG. 3 is a schematic cross-sectional view of four exemplary embodiments of the prefabricated interior finish layer assemblies 300, 325, 350 and 375 of the present invention. The prefabricated interior finish layer assemblies of the present invention, and particularly, prefabricated interior finish layer assemblies 300, 325, 350 and 375 can be prefabricated and affixed to a structural layer (e.g., a wood based structural frame, a hybrid, wood-metal structural frame, a concrete layer, light-gauge steel frame, or structural steel frame; preferably a hybrid, wood-metal structural frame) of a wall of a building at the building site to form a building wall assembly as, for example, shown in FIG. 1.

The different prefabricated interior finish layer assemblies 300, 325, 350 and 375 shown in FIG. 3 each include an interior finish layer 310, at least two sleepers 108, and a protective track 305, 330, 355 and 380, respectively. The protective tracks include a shielding member 310, 335, 360 and 385, respectively. The interior finish layer 110 is affixed to the sleepers 108. The protective tracks 305, 330, 355 and 380, respectively, have a smaller dimension than the sleepers in perpendicular direction to the interior finish layer 110. This allows the protective tracks to be positioned in a space that is formed between the interior finish layer and a structural layer when the interior finish layer is affixed to the structural layer, as can be seen, for example, in FIG. 1 as space 133. The sleepers 108 are suitably positioned to allow secure affixment of the interior finish layer 110 to a structural layer, e.g. structural layer 105 in FIG. 1.

The protective tracks 305, 330, 355 and 380 in FIG. 3 are exemplary. Many other protective tracks that can be substituted with the particular protective tracks in FIG. 3 are readily envisionable. The protective tracks 305, 330, 355 and 380 include a shielding member 310, 335, 360 and 385, respectively, and a holding member 315, 340, 365 and 390, respectively (the dividing line between these members is indicated with a dotted line), the shielding members and/or the respective holding members providing a holding volume 320, 345, 370 and 395, respectively, adapted for holding wiring and/or plumbing 140. The holding volume can be a single volume as is the case for holding volumes 320, 345, and 370, or it can comprise several compartments which separate, organize, and/or insulate wiring and/or plumbing as is the case for holding volume 395 which includes three separate compartments. The protective tracks of FIG. 3 can be made of a wide variety of material or material combination in a wide variety of shape or form that fulfills the required dual functionality of shielding a holding volume (be it a single volume or a plurality of compartments) from impacts originating through the interior finish layer 100 and holding wiring and/or plumbing 140 in the holding volume. Preferably, to reduce cost and allow increased material selection, the protective track has a shielding member that shields the holding volume from one side only (i.e., the side facing the interior finish layer 100), as is the case for the protective tracks 305, 330, 355 and 380 of FIG. 3. Accordingly, preferably, the shielding members 310, 335, 360 and 385 are positioned between the respective holding volume 320, 345, 370 and 395 and the interior finish layer 110. Generally, and also for the exemplary embodiments of FIGS. 1 to 3, not all of the material between the holding volume and the interior finish layer has to function as a shielding member, although, typically, all of the material does function as a shielding member. Further, generally, the shielding member is dimensioned and positioned between the holding volume and the interior finish layer to reduce or prevent impact (and potential damage to any wiring and plumbing in the holding volume) along an impact vector 322 substantially perpendicular to the interior finish layer; alternatively, the shielding member can be dimensioned and positioned to reduce or prevent impact (and potential damage to any wiring and plumbing in the holding volume) along an impact vector 322 with and impact angle 323 (i.e., angle of the impact vector relative to a line perpendicular to the interior finish layer;) of up to 15 degrees, up to 25 degrees, or up to 45 degrees; noting that the impact vector and respective impact angle is not limited to be within a plane perpendicular to the interior finish layer (e.g., the paper plane of FIG. 3; in other words, the impact vector can be located within a cone around the line perpendicular to the interior finish layer). For ease of illustration, the impact vector 322 and 323 have only been indicated for the first shown embodiment of FIG. 2.

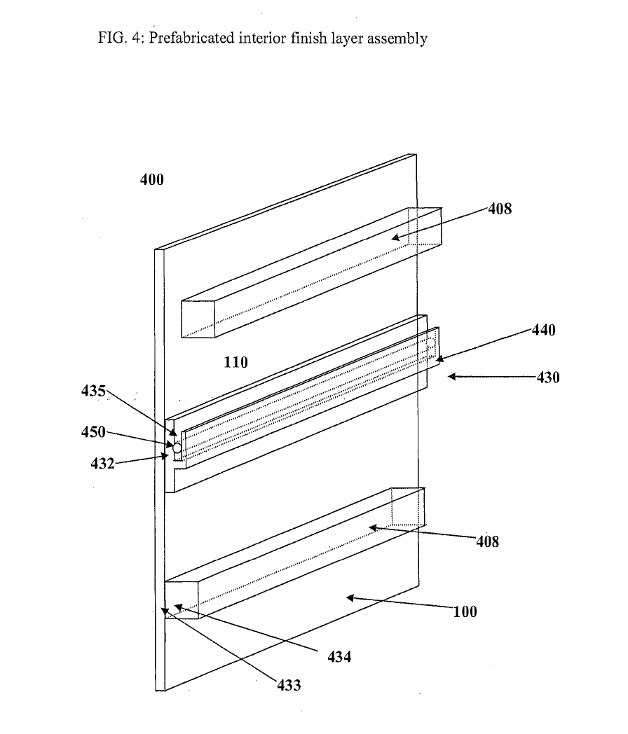

FIG. 4 is a schematic isometric view of a prefabricated interior finish layer assembly 400 having a cross-section similar to the prefabricated interior finish layer assembly embodiment 350 depicted in FIG. 3(c). The prefabricated interior finish layer assembly 400 can be prefabricated and affixed to a structural layer (e.g. a wood based structural frame, a hybrid, wood-metal structural frame, a concrete layer, light-gauge steel frame, or structural steel frame; preferably a hybrid, wood-metal structural frame) of a wall of a building at the building site to form a building wall assembly as, for example, shown in FIG. 1.

The prefabricated interior finish layer assembly 400 includes an interior finish layer 110, at least two sleepers 408, and a protective track 430. The protective track includes a shielding member 432. The interior finish layer 110 is affixed to the sleepers 408. The protective track 430 has a smaller dimension than the sleepers in perpendicular direction to the interior finish layer 110. This allows the protective track to be positioned in a space that is formed between the interior finish layer and a structural layer when the interior finish layer is affixed to the structural layer, as can be seen, for example, in FIG. 1 as space 133. The sleepers 408 are suitably positioned to allow secure affixment of the interior finish layer 110 to a structural layer, e.g. structural layer 105 in FIG. 1.

A sleeper can be positioned such that the side edge of the interior finish layer 433 substantially aligns with the side edge 434 of the sleeper. They can also be positioned such that the side edges of the interior finish layer does not align with the side edge of the sleeper(s), as is the case, for example, for the other three side edges of the two sleepers 408.

The protective tracks 430 includes a shielding member 432 and a holding member 440. The shielding member 432 and holding member 440 provide a holding volume 450 adapted for holding wiring and/or plumbing 140. The holding volume can be a single volume as shown, or it can comprise several compartments which separate, organize, secure, and/or insulate wiring and/or plumbing as is the case for holding volume 395 in FIG. 3, which includes three separate compartments. The protective track of FIG. 4 can be made of a wide variety of material or material combination in a wide variety of shape or form that fulfills the required dual functionality of shielding a holding volume (be it a single volume or a plurality of compartments) from impacts originating through the interior finish layer 100 and holding wiring and/or plumbing 140 in the holding volume. Preferably, to reduce cost and allow increased material selection, the protective track has a shielding member that shields the holding volume from one side only (e.g., the side facing the interior finish layer 100), as is the case for the protective track 430. Further, generally, and also in the case of the embodiments of FIGS. 1 to 3, the holding member (e.g., 440) can be a continuous solid support, that is, without gaps along the length of the protective track, as is the case for protective track 430. Alternatively, the holding member can provide intermittent support adapted to hold the wiring and/or plumbing securely positioned behind the shielding element. For example, the holding member can alternatively be a plurality of hooks or clamping members that hold the wiring and/or plumbing, or, to reduce material usage, the holding member can be perforated, have gaps, or be in the form of a series of smaller support members spaced out along the length of the shielding element.

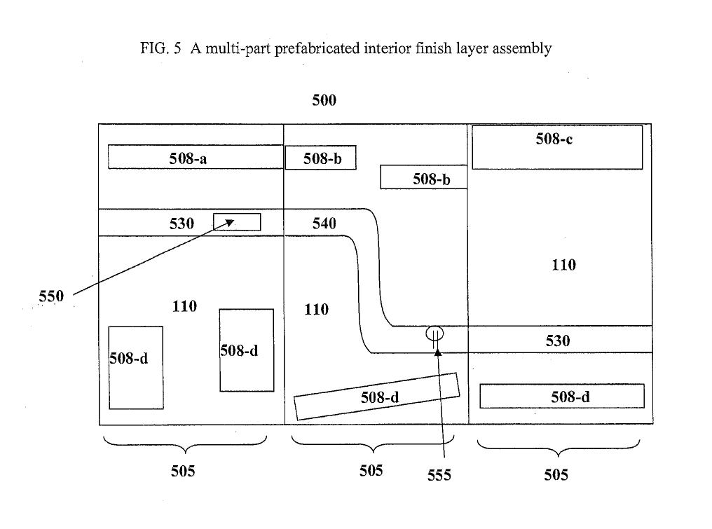

FIG. 5 is a schematic elevational view of a multi-part (here, three part) prefabricated interior finish layer assembly 500 in connected configuration. For illustration purposes, an embodiment having three prefabricated interior finish layer assembly parts 505 is shown. Generally, the multi-part prefabricated interior finish layer assemblies of the present invention are not limited as to the number of parts that are being contemplated; however, typically, a number of parts between 1 and a total number of parts required to finish interior walls of a building room or entire building are contemplated. This total number in the entire building is usually in the range between 10 and 1000. Further, the interior finish layer assembly parts are not limited to the particular arrangement or pattern shown in FIG. 4, the multi-part prefabricated interior finish layer assemblies of the present invention can be designed based on any suitable final arrangement or pattern of prefabricated interior finish layer assemblies. This includes the arrangement of the parts forming finished corners of a building room. Accordingly, a substantial amount of finishing, electrical wiring and/or plumbing of part of a wall, an entire wall, a plurality of walls of a room, or even an entire multi-room building can be prefabricated. The multi-part prefabricated interior finish layer assemblies of the present invention are designed such that they complement not only with a structural layer but also such that prefabricated interior finish layer assemblies that will be adjacent when connected to the structural layer complement each other. In this respect, it is particularly important that the respective protective tracks complement each other to allow continuous shielding of wiring and/or plumbing running in the protective tracks across the plurality of the installed prefabricated interior finish layer assemblies.

As shown in FIG. 5, and also generally, the sleepers (e.g., 508-a to d) can be of varying shape and size, and can be affixed to the interior finish layer 100 in different positions, as long as the interior finish layer can be securely affixed with the sleepers to the structural layer while meeting any applicable building code standards; and the sleepers, the structural layer and the interior finish layer, when connected, provide a space for the protective track to run through. The protective tracks of the present invention are not limited to straight tracks, for example, such as tracks 530; they can be curved as shown, for example, with track 540. They can also branch from a single track into a plurality of tracks and vice versa. Accordingly, complex electrical wiring and/or plumbing can be achieved. Additionally, the protective tracks of the present invention can have openings or additional tracks positioned inward (i.e., towards and/or into the structural layer space), for example, as shown with feature 550. Further additionally, the protective tracks can be designed to include one or more electrical outlets and/or to accommodate one or more separate electrical outlet boxes installed in the interior finish layer, for example, outlet 555.

The protective tracks of the present invention can have a shielding member and holding member made of the same material, or they materials can be different. For example, a shielding member can be a metal member whereas the holding member can be a plastic member which separates and/or insulates any electrical wiring in the holding volume from the metal shielding member.

The protective tracks of the present invention are non-structural, that is, while the protective tracks are designed to support the electrical wiring and/or plumbing, and to shield from impacts as described above, they are not designed to carry structural loads, in contrast to members of the structural layer.

The sleepers of the present invention are preferably wood sleepers, more preferably, they are nailing strips; however, these can also be made of metals or polymers. The sleepers are affixed to the interior finish layer using methods known in the art. Preferably, they are attached prone to the structural layer, e.g., prone to wall studs (and not from the sides) of the structural layer. For example, they can be affixed to the interior finish layer using fastening means such as nails and screws, or they can be glued. In a building wall assembly, the sleepers are further affixed to the structural layer using methods known in the art. For example, they can be affixed to the structural layer using fastening means such as nails and screws, or they can be glued.

When the protective tracks of the present invention are part of a prefabricated interior finish layer assembly, they are affixed to the interior finish layer or structural layer using methods known in the art. For example, they can be affixed to the interior finish layer or structural layer using fastening means such as nails and screws, or they can be glued. When the protective tracks of the present invention are not part of a prefabricated interior finish layer assembly, for example, if they are installed at the building site, they are not limited to being attached to the interior finish layer. Generally, the protective tracks of the present invention can be affixed to the structural layer and/or the interior finish layer. Preferably, when the protective tracks are affixed to a structural layer, they are affixed prone to the structural layer, e.g., prone to wall studs (and not from the sides) of the structural layer.

The shielding members of the present invention are dimensioned and made of a material suitable for shielding the holding volume to the extent required by applicable building codes. Typically, the shielding member is made of one or more metals, for example, stainless steel. The presence of the shielding member between the holding volume and the interior finish layer allows to run electrical wiring and/or plumbing in close proximity (e.g., one or two inches from the room-facing surface of the interior finish layer), which without shielding member would not be allowed, for example, by U.S. building codes.

The prefabricated interior finish layer assemblies of the present invention are particularly advantageously used with structural layers that are metal frame based, and particularly, in prefabricating foldable building modules and buildings having metal structural frames as structural layers. The building technology of the present invention, and particularly, the building wall assemblies and prefabricated interior finish layer assemblies of the present invention can be used with the foldable building modules and buildings described in International Patent Application No. PCT/US2010/050041, filed Sep. 23, 2010, and published as WO2011/038145, in International Patent Application No. PCT/US2011/029643, filed Mar. 23, 2011, and in International Patent Application No. PCT/US2011/054348, filed Sep. 30, 2011.

The building modules of the present invention can be prefabricated such that the building module, after unfolding on the building site and connecting of removable sections (such as roof elements and non-structural interior walls), are substantially in finished condition, not considering any open sides of the building modules which are adapted for connecting with building units and/or wall panels. That is, they do not typically require or at least significantly reduce the addition of interior and exterior finish materials with the exception of minor, non-structural finishing in areas required for folding movement. Further, typically, the houses of the present invention include roof sections that are panelized but can be easily installed at the building site.

Further, flexible piping and electrical wiring can be chased through the space (e.g., space 133 in FIG. 1) between the metal structural frames and the interior finish layer of both fixed and foldably connected panels of the foldable building units of the present invention.

Structural layers of walls of a foldable building of the present invention can include structural metal frames which are typically combined with wooden or light-gauge metal intermediate elements to form lightweight metal and wood/light-gauge metal hybrid structures as part of fixed or foldable wall panels, in which the frame elements provide structural stability and the wooden or light-gauge metal intermediate elements provide substantial lateral structural resistance and/or are used to affix the prefabricated interior finish layer assemblies of the present invention and exterior finishing material or elements using standard construction approaches, reducing labor training and associated costs.

By forming indirect connections of the interior finish layer with the structural metal frames (through sleepers affixed to intermediate elements of the structural layer) a “multi-tolerance” building approach that disaggregates and cushions brittle or otherwise fragile finish materials from the vibrational, kinetic and settling forces applied to the structural frame during shipping, setting, unfolding and settling of the prefabricated foldable building modules is achieved.

The interior finish layer of the present invention can be an interior wall panel such as gypsum board and can include final interior finishing, such as trim, paint or wallpaper.

A “structural layer” as used herein, refers to the totality of structural members (e.g., steel structural members) of a building wall or building wall assembly that are primarily responsible for providing structural stability of the building module or building by transmitting loads (e.g., static, dynamic, and/or vibrational loads) to the ground. The structural layer can include members that are made of a plurality of materials in various forms and dimensions. Suitable materials that can be used include but are not limited to metal (e.g., aluminum or steel), wood, and polymers.

A “sleeper” as used herein, refers to a member (typically, a wood member such as a nailing strip) which serves to support and fasten an interior finish layer to a structural layer.

The relevant teachings of these patent applications, and all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed:

1. A building wall assembly comprising a structural layer, at least two sleepers, an interior finish layer, and a protective track; wherein the interior finish layer is affixed to the sleepers and the sleepers are affixed to the structural layer such as to space apart the structural layer and the interior finish layer to form a space, the protective track being positioned within the space.

2. The building wall assembly of claim 1, wherein the protective track is affixed to the interior finish layer.

3. The building wall assembly of claim 1 or 2, wherein the structural layer comprises at least two wall studs, the sleepers are affixed to the structural layer by being affixed to the wall studs, and at least part of the protective track is positioned between i) the wall studs and the interior finish layer and ii) between the sleepers.

4. The building wall assembly of any one of the preceding claims, wherein the protective track comprises a holding volume adapted for holding electrical or plumbing material and a shielding member, the shielding member being between the holding volume and the interior finish layer.

5. The building wall assembly of any one of the preceding claims, wherein the structural layer is part of a structural envelope of a steel-framed building.

6. The building wall assembly of any one of the preceding claims, wherein the structural layer is part of a structural envelope of a foldable building.

7. The building wall assembly of any one of claims 3 to 5, wherein the studs are connected through blocking members to steel structural members.

8. A prefabricated interior finish layer assembly comprising an interior finish layer and a protective track; wherein the interior finish layer is affixed to the sleepers, the protective track is affixed to the interior finish layer, and the protective track has a smaller dimension than the sleepers in perpendicular direction to the interior finish layer.

9. The prefabricated interior finish layer assembly of claim 8, wherein the protective track comprises a holding volume adapted for holding electrical or plumbing material and a shielding member, the shielding member being between the holding volume and the interior finish layer.

10. The prefabricated interior finish layer assembly of anyone of claims 8 to 9, wherein the protective track includes electrical wiring or plumbing.

11. The prefabricated interior finish layer assembly of claim 8, wherein the electrical wiring or plumbing has connectors for connection between electrical wiring or plumbing of one prefabricated interior finish layer with electrical wiring or plumbing of another adjacent prefabricated interior finish layer.

12. A multi-part prefabricated interior finish layer assembly comprising a plurality of unconnected prefabricated interior finish layer assemblies of any one of claims 8 to 11, the prefabricated interior finish layer assemblies, when connected to each other forming a continuous interior finish layer in which electrical wiring and/or plumbing is continuously shielded by the protective tracks across the prefabricated interior finish layer assemblies.

13. A building wall assembly manufactured in a process comprising building a structural layer of a wall and affixing a prefabricated interior finish layer assembly to the structural layer such as to space apart the structural layer and the interior finish layer to form a space, a protective track being positioned within the space.

14. The building wall assembly of claim 12, wherein the protective track is affixed to the structural layer and/or the interior finish layer.

15. The building wall assembly of claim 12, wherein the structural layer comprises at least two wall structural members, the interior finish layer has sleepers affixed thereto, the sleepers are affixed to the structural layer by being affixed to the wall structural members, and at least part of the protective track is positioned between i) the wall structural members and the interior finish layer and ii) between the sleepers.

16. The building wall assembly of any one of claims 13 to 15, wherein the protective track comprises a holding volume adapted for holding electrical or plumbing material and a shielding member, the shielding member being between the holding volume and the interior finish layer.

17. The building wall assembly of any one of claims 13 to 16, wherein the structural layer is part of a structural envelope of a foldable building.

18. The building wall assembly of any one of claims 13 to 17, wherein the prefabricated interior finish layer assembly is part of a multi-part prefabricated interior finish layer assembly.

19. A method of manufacturing a prefabricated interior finish layer assembly, comprising (i) affixing a plurality of sleepers to an interior finish layer, and (ii) affixing at least one protective track to the interior finish layer.

20. The method of claim 19, wherein the protective track comprises a holding volume adapted for holding electrical and/or plumbing material and a shielding member, the shielding member being between the holding volume and the interior finish layer, the method further comprising positioning electrical wiring and/or plumbing within the holding volume.

21. A method of manufacturing a multi-part prefabricated interior finish layer assembly, comprising (i) affixing a plurality of sleepers to each of a plurality of unconnected interior finish layers, and (ii) affixing at least one protective track to each of the plurality of interior finish layers, the plurality of interior finish layers, when connected, complementing each other to form a continuous interior finish layer, and adjacent protective tracks of the plurality of interior finish layers connecting to form a continuous protective track along the continuous interior finish layer.

22. The method of claim 21, wherein the protective tracks comprise a holding volume adapted for holding electrical and/or plumbing material and a shielding member, the shielding member being between the holding volume and the interior finish layer, the method further comprising positioning electrical wiring and/or plumbing within the holding volume.

23. A method of manufacturing a building wall assembly comprising (a) building a structural layer of a wall, (i) affixing a plurality of sleepers to an interior finish layer, (ii) affixing a protective track to the interior finish layer and/or the structural layer, (iii) connecting the interior finish layer to the structural layer by affixing the sleepers to the structural layer such as to space apart the structural layer and the interior finish layer to form a space, the protective track being positioned within the space.

24. The method of claim 23, wherein the structural layer comprises at least two wall studs, the sleepers are affixed to the structural layer by being affixed to the wall studs, and at least part of the protective track is positioned between i) the wall studs and the interior finish layer and ii) between the sleepers.

25. The method of any one of claims 21 to 24, wherein the protective track comprises a holding volume adapted for holding electrical or plumbing material and a shielding member, the shielding member being between the holding volume and the interior finish layer.

26. The method of any one of claims 21 to 25, further comprising positioning electrical wiring and/or plumbing within the holding volume of the protective track prior to affixing the sleepers to the structural layer.

27. The method of any one of claims 21 to 25, further comprising positioning electrical wiring and/or plumbing within the holding volume of the protective track subsequent to affixing the sleepers to the structural layer.

28. A folded building having a plurality of walls, one or more of the walls comprising a building wall assembly of anyone of claims 1 to 6 and 13 to 18.
